(19) United States
(12) Patent Application Publication
(10) Pub. No.: US 2005/0013743 A1
(43) Pub. Date: Jan. 20, 2005

(54) I-shaped slit in a lidstock covering an array of aliquot vessels

(76) Inventors: Edward Francis Farina, Oxford, PA (US); Antoine Elias Haddad, Newark, DE (US); Leland Kay Jordan III, Lincoln University, PA (US)

Correspondence Address: DADE BEHRING INC.;LEGAL DEPARTMENT, 1717 DEERFIELD ROAD, DEERFIELD, IL, 60015, US

(21) Appl. No.: 10/797,817

(22) Filed: Mar. 10, 2004

Related U.S. Application Data
(63) Continuation-in-part of application No. 10/622,671, filed on Jul. 18, 2003, now abandoned.

(51) Int. Cl. B01L 3/00

(52) U.S. Cl. 422/99

(57) ABSTRACT

A lidstock for a open sample container having a plurality of slits to form segment intersections that facilitate penetration by an aspiration probe, the segment intersections displaced from the location for penetration by the probe.

### FIELD OF THE INVENTION

The present invention relates to a method and apparatus for automatically processing a patient's biological fluids such as urine, blood serum, plasma, cerebrospinal fluid and the like. In particular, the present invention provides an improved lidstock for protectively covering an array of aliquot wells during multiple penetrations of a probe aspirating a portion of patient liquid sample.

### BACKGROUND OF THE INVENTION

Various types of tests related to patient diagnosis and therapy can be performed by analysis assays of a sample of a patient's infections, bodily fluids or abscesses for an analyte of interest. Such patient samples are typically liquids placed in sample vials, are extracted from the vials, combined with various reagents in special reaction vessels or tubes, incubated, and analyzed to aid in treatment of the patient. In a typical clinical chemical analysis, one or two assay reagents are added at separate times to a liquid sample having a known concentration, the sample-reagent combination is mixed and incubated. Interrogating measurements, turbidimetric or fluorometric or absorption readings or the like, are made to ascertain end-point or rate values from which an amount of analyte may be determined, using well-known calibration techniques.

Although various known clinical analyzers for chemical, immunochemical and biological testing of samples are available, analytical clinical technology is challenged by increasing needs for improved levels of analysis. Automated clinical analyzers improve operating efficiency by providing results more rapidly while minimizing operator or technician error. However, due to increasing demands on clinical laboratories regarding assay throughput, new assays for additional analytes, accuracy of analytical results, and low reagent consumption, there continues to be a need for improvements in the overall performance of automated clinical analyzers. In particular, the efficiency of patient sample handling continually needs to be increased, regardless of the assay to be performed.

An important contributor to maintaining a high efficiency in throughput of patient samples is the ability to quickly and securely introduce a plurality of samples to the sample testing portion of an analyzer. Patient samples are typically held in a container such as a sample cup, a primary tube, or any other suitable container and may be open at its top or closed with a stopper or lid or the like at its top. To increase handling efficiency, the containers may then be placed into a sample rack adapted to support multiple sample containers generally in an upright orientation.

The sample rack is usually placed by an operator in an input portion of the analyzer and then moved automatically moved by the analyzer to a location where a portion of the liquid patient sample, hereinafter described as a aliquot, is extracted, usually by aspiration using a hollow, needle like probe from the sample container. Afterwards, the aliquot may be dispensed directly into a reaction cuvette for testing in the analyzer or into a plurality of interim vessels or wells formed as an integral array of small open cup-like vessels, herein called an aliquot vessel array, like that described in U.S. patent Ser. No. 10/037,512, assigned to the assignee of the present invention.

In modern analyzers, there is a desire to minimize the size required of a patient's sample(s) which has led to the necessity to automate the handling and analysis of a large number of small-sized patient samples. Aliquot vessel arrays have been found to be useful in increasing the efficiency of automation; however, as sample sizes are reduced, it is increasingly important to minimize evaporation of sample liquids and also eliminate concerns for contamination of sample liquids. It is desirable that such an aliquot vessel be covered with a lidstock so as to minimize evaporation and cross-contamination of liquids contained therein. It is also desirable that such a lidstock be capable of being penetrated multiple times by an aspiration probe without adversely affecting its ability to minimize evaporation and cross-contamination. It is further desirable that such a lidstock enhance venting of an aspiration probe during aspiration of liquids. While there has been some progress towards these objectives with commercially available lidstocks, there remains a further need for a lidstock capable of being penetrated a large number of times without adversely affecting the protection afforded liquids within vessel arrays.

U S. Pat. No. 6,173,851 discloses an opaque container having one opening, a child resistant closure with an aperture that extends over the opening, and a multi-segmented plastic slitted membrane covering the aperture.

U S. Pat. No. 6,149,872 discloses modular reagent which is sealed with a silicone rubber disk, which is slit in the shape of a cross, a star or a straight line.

U S. Pat. No. 6,030,582 discloses a self-resealing container cap having a puncturable septum of elastomeric material supported by the cap periphery. The septum is puncturable and self-resealing.

U S. Pat. No. 6,027,694 discloses a multi-well microplate, a plurality of vent caps and a porous vent film.

U S. Pat. No. 5,789,251 discloses a microplate with vertical wells covered by a layer of film to prevent the evaporation of liquid. An X-shaped slit is formed in the film defining a plurality of adjacent segments so that an inserted pipette bends the edges of the segments downwardly.

U S. Pat. No. 5,397,023 discloses a straw-insertable disposable lid for covering a cup, the lid having a plurality of intersecting lines of weakness shaped like a cross each extending between two ends with the lines of weakness adapted to permit the insertion of a drinking straw through the lid.

U S. Pat. No. 5,147,065 discloses a disposable cup lid with intersecting straw insertion slits and rip-stop end cuts located transversely to and spaced from the ends of the straw insertion slits.

U S. Pat. No. 4,847,050 discloses a lid comprising a first sheet with a receptacle, a second sheet overlying and joined to the first sheet about the periphery of the receptacle, and a resilient elastomeric pad disposed within the receptacle. The pad is slit in a straight line so that a probe may be inserted through the lid.

U S. Pat. No. 3,785,773 discloses a cover plate having multiple apertures each having multiple sectors formed by incising divisions radially outwardly from the center of the apertures.

U S. Pat. No. 2,436,291 discloses a self-sealing closure for a supply container having juxtaposed diaphragms each with a slit.

Des. 264,244 discloses a medicinal sponge container with a slitted cover.

From this discussion, it may be seen that while there are several approaches to improving of the state-of-art in self-sealing coverings, there remains an unmet need for a lidstock having an access slit especially shaped to enable probe venting during aspiration as well as to maintain sealing characteristics even when penetrated multiple times.

### SUMMARY OF THE INVENTION

The present invention provides protection to an aliquot vessel array by using a lidstock capable of being penetrated a large number of times without adversely affecting the protection afforded liquids within aliquot vessel arrays. Handling features designed into the aliquot vessel array ensure highly accurate positioning within sampling tracks where sample originally dispensed into individual vessels may be aspirated a large number of times for multiple testing of the sample liquid. As provided by the present invention, the aliquot vessel array is covered with an evaporation protection and venting lidstock having a distributed plurality of capital I-shaped slits, each capital I-shaped slit centered over an individual vessel in the aliquot vessel array. Because of the increased flexibility afforded by the uniquely shaped intersecting mirror-image portions of the I-shaped slit, multiple aspirations may be made through the lidstock without impairing its ability to protect liquids in the individual vessels and also enhancing the venting of an aspiration probe during aspiration of liquids contained in the vessels.

### BRIEF DESCRIPTION OF THE DRAWINGS

The invention will be more fully understood from the following detailed description thereof taken in connection with the accompanying drawings which form a part of this application and in which:

FIG. 1 is a schematic plan view of an automated analyzer in which the present invention may be employed to advantage;

FIG. 2 is an enlarged schematic plan view of a portion of the analyzer of FIG. 1;

FIG. 3 is a perspective elevation view of an automated aliquot vessel array storage and handling unit;

FIG. 4 is a perspective elevation view of an aliquot vessel array;

FIG. 5 is a perspective view of a typical vessel array lidstock;

FIG. 6 is a bottom view of the vessel array lidstock of FIG. 5 illustrating the present invention;

FIG. 6A is an enlarged view of an I-shaped slit of the present invention in the vessel array lidstock of FIG. 6;

FIG. 6B is a cross-section view of the vessel array lidstock of FIG. 6;

FIG. 6C is a first alteration of the I-shaped slit of the present invention;

FIG. 6D is a second alteration of the I-shaped slit of the present invention;

FIG. 6E is a second alteration of the I-shaped slit of the present invention;

FIG. 6F is a fourth alteration of the I-shaped slit of the present invention;

FIG. 6G is a fifth alteration of the I-shaped slit of the present invention;

FIG. 7 illustrates the aliquot vessel array lidstock of FIG. 5 as it is partially applied to the aliquot vessel array of FIG. 4;

FIG. 8 illustrates the aliquot vessel array lidstock of FIG. 5 fully applied to the aliquot vessel array of FIG. 4;

FIG. 9 is a cross-section view of the vessel array lidstock of FIG. 5 illustrating an alternate embodiment of the present invention;

FIG. 10 is a partial perspective view of the vessel array lidstock of FIG. 9; and,

FIG. 11 is a-perspective view of the entire vessel array lidstock of FIG. 9.

### DETAILED DESCRIPTION OF THE INVENTION

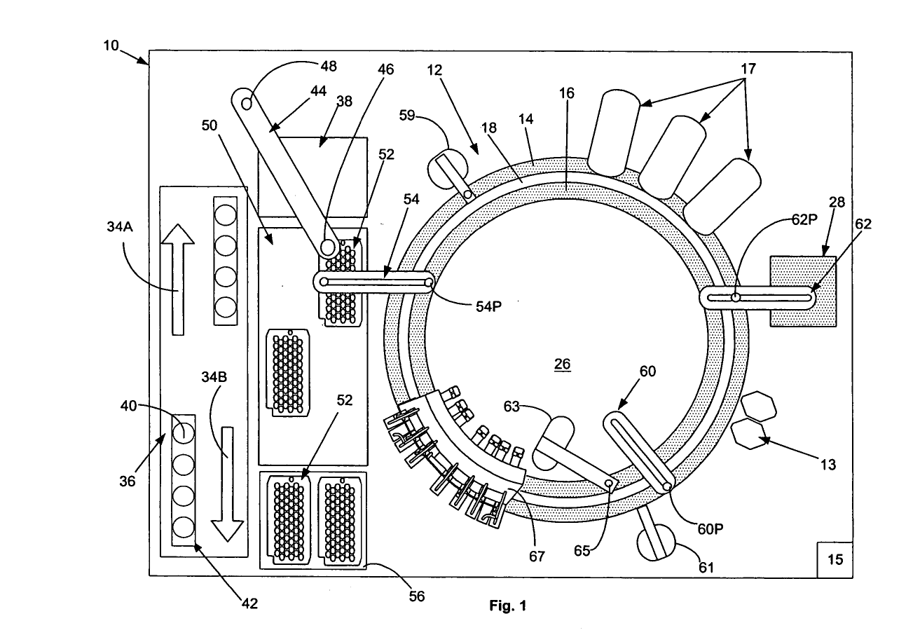

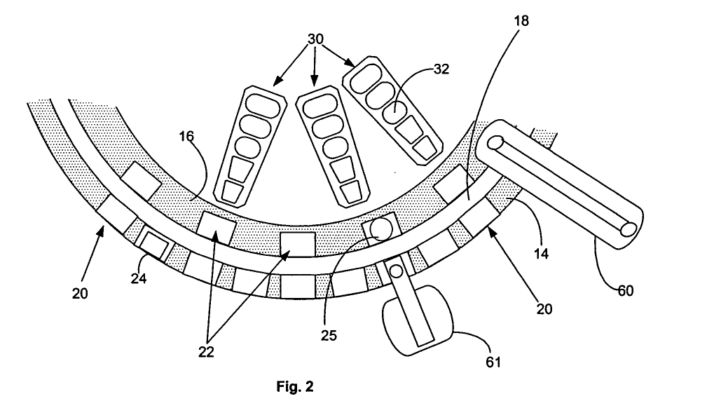

FIG. 1, taken with FIG. 2, shows schematically the elements of an automatic chemical analyzer 10 in which the present invention may be advantageously practiced, analyzer 10 comprising a reaction carousel 12 supporting an outer cuvette carousel 14 having cuvette ports 20 formed therein and an inner cuvette carousel 16 having cuvette ports 22 formed therein, the outer cuvette carousel 14 and inner cuvette carousel 16 being separated by a open groove 18. Cuvette ports 20 and 22 are adapted to receive a plurality of reaction cuvettes 24 that contain various reagents and sample liquids. Reaction carousel 12 is rotatable using stepwise movements in a constant direction at a constant velocity, the stepwise movements being separated by a constant dwell time during which carousel 12 is maintained stationary and computer controlled assay operational devices 13, such as sensors, reagent add stations, mixing stations and the like, operate as needed on an assay mixture contained within a cuvette 24.

Analyzer 10 is controlled by software executed by the computer 15 based on computer programs written in a machine language like that used on the Dimension® clinical chemistry analyzer sold by Dade Behring Inc, of Deerfield, Ill., and widely used by those skilled in the art of computer-based electromechanical control programming. Computer 15 also executes application software programs for performing assays conducted by various analyzing means 17 within analyzer 10.

Temperature-controlled reagent storage areas 26 and 28 store a plurality of multi-compartment elongate reagent cartridges 30 like that described in co-pending application Ser. No. 09/949,132 assigned to the assignee of the present invention, and containing reagents in wells 32 as necessary to perform a given assay. Shuttle means move individual cartridges 30 to reagenting locations for access by reagent probes 60P and 62P.

A bidirectional incoming and outgoing sample tube transport system 36 having input lane 36A and output lane 36B transports incoming individual sample tubes 40 containing liquid specimens to be tested and mounted in sample tube racks 42 into the sampling arc of a liquid sampling arm 44. Liquid specimens contained in sample tubes 40 are identified by reading bar coded indicia placed thereon using a conventional bar code reader to determine, among other items, a patient's identity, the tests to be performed, if a sample aliquot is to be retained within analyzer 10 and if so, for what period of time. It is also common practice to place bar coded indicia on sample tube racks 42 and employ a large number of bar code readers installed throughout analyzer 10 to ascertain, control and track the location of sample tubes 40 and sample tube racks 42.

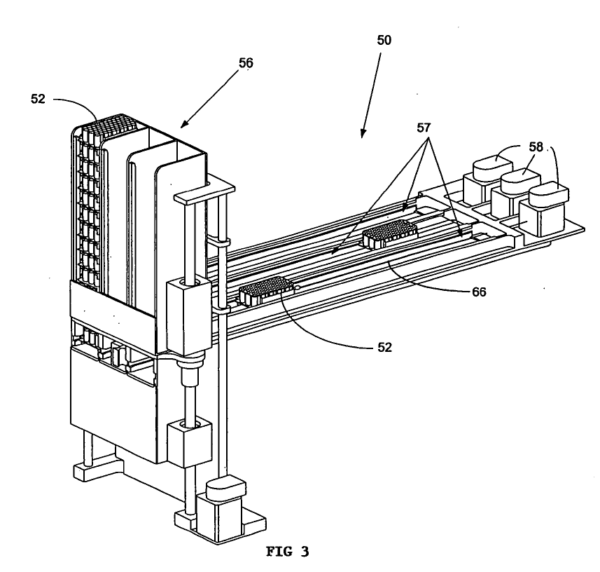

Sampling arm 44 supports a liquid sampling probe 46 mounted to a rotatable shaft 48 so that movement of sampling arm 44 describes an arc intersecting the sample tube transport system 36 and an aliquot vessel array transport system 50, as seen in FIG. 3. Sampling arm 44 is operable to aspirate liquid sample from sample tubes 40 and to dispense an aliquot sample into one or more of a plurality of vessels 52V in aliquot vessel array 52, as seen in FIG. 4, depending on the quantity of sample required to perform the requisite assays and to provide for a sample aliquot to be retained by analyzer 10 within environmental chamber 38.

Aliquot vessel array transport system 50 comprises an aliquot vessel array storage and dispense module 56 and a number of linear drive motors 58 adapted to bi-directionally translate aliquot vessel arrays 52 within a number of aliquot vessel array tracks 57 below a sample aspiration and dispense arm 54 located proximate reaction carousel 12. Sample aspiration and dispense arm 54 is controlled by computer 15 and is adapted to aspirate a controlled amount of sample from individual vessels 52V positioned at a sampling location within a track 57 using a conventional liquid probe 54P and to then shuttle liquid probe 54P to a dispensing location where an appropriate amount of aspirated sample is dispensed into one or more cuvettes 24 in cuvette ports 20 and 22 for testing by analyzer 10 for one or more analytes. After sample has been dispensed into reaction cuvettes 24, conventional transfer means move aliquot vessel arrays 52 as required between aliquot vessel array transport system 50, environmental chamber 38 and a disposal area, not shown.

A number of reagent aspiration and dispense arms 60 and 62 comprising a pair of conventional liquid reagent probes, 60P and 62P, respectively, are independently mounted and translatable between reagent storage areas 26 and 28, respectively. Probes 60P and 62P comprise conventional mechanisms for aspirating reagents required to conduct specified assays at a reagenting location from wells 32 in an appropriate reagent cartridge 30, the probes 60P and 62P subsequently being shuttled to a reagent dispensing location where reagent(s) are dispensed into reaction cuvettes 24. A number of reagent cartridges 30 are inventoried in controlled environmental conditions inside reagent storage areas 26 and 28 and a key factor in maintaining high assay throughput is the ability to quickly and accurately shuttle reagent cartridges 30 inside reagent storage areas 26 and 28 to reagenting locations for access by probes 60P and 62P.

Cuvette load and unload stations 61 and 63, respectively, are positioned proximate outer cuvette carousel 14 and are conventionally adapted to load reaction cuvettes 24 into cuvette ports 20 and 22 seen in FIG. 2, and to unload used reaction cuvettes 24 from cuvette ports 20 and 22 after an assay has been completed therein, using for example a translatable robotic arm 65 on each of load and unload stations 61 and 63. In operation, used cuvettes 24 in which an assay has been finally conducted, are removed from cuvette ports 20 and 22 and replaced with cleaned used cuvettes 24. Subsequent assays are conducted in cleaned used cuvettes 24 unless dictated otherwise for reasons like disclosed in co-pending application Ser. No. 10/318,804 assigned to the assignee of the present invention. Unloaded cleaned used cuvettes 24 are deposited into a cuvette wash station typically comprising stationary sources of pulsed jets streams of a cleaning detergent in heated water, pulsed jets streams of distilled water, and continuous stream of drying air. After being washed and dried, cleaned used cuvettes 24 are inventoried, for example in a continuously circulating serpentine track having inventory slots for storing reaction cuvettes 24.

Because a number of different assays may be required for the sample contained in a single vessel 52V, aliquot vessel array 52 may be moved a number of different times within track 57 so that multiple aliquots of sample may be aspirated from vessels 52V. It is advantageous to minimize unwanted sample evaporation losses. Aliquot vessel array 52, described in co-pending application Ser. No. 10/037,512 assigned to the assignee of the present invention and shown in FIG. 4, is thus equipped with a zero-backlash hitch 64 so that an inter-locking finger-latch 65 and a linear drive mechanism 66 driven by motor 58 are able to accurately position aliquot vessel array 52 within track 57 at a single sampling location. It is therefore important that aliquot vessel array 52 be covered with a lidstock especially designed to withstand multiple sample aspiration by probe 54P without adversely affecting the ability to protect liquids in the individual vessels. Further, because sample aspirations are often of a very small volume of liquid from vessels 52V, it is important to provide sufficient venting of probe 54P during aspiration. Aspiration probes like probe 54P are connected to a vacuum source, frequently a displacement pump, and the volume of an aspirated sample will be the intended volume when aspiration is from an open sample vessel. When the sample vessel is closed, however, it is known that a partial vacuum or positive pressure may be formed within the sample vessel during the aspiration process adversely affecting the measured volume of the aspirated sample.

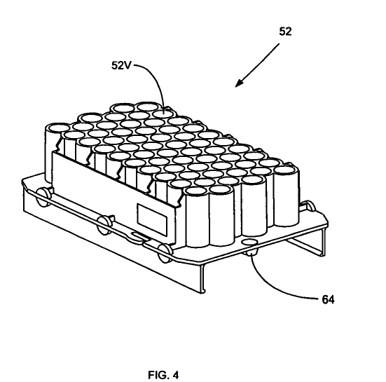

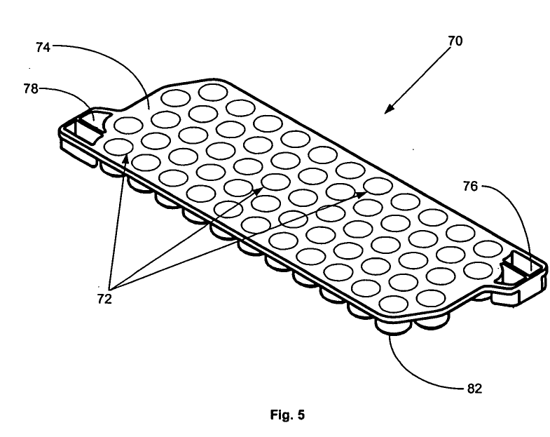

FIG. 5 shows one lidstock 70 that has been discovered to withstand multiple penetrations by probe 54P and to provide sufficient venting during sample aspiration. In a typical embodiment, lidstock 70 is of an elongate shape and comprising a regularly arrayed plurality of open generally circular wells 72 depending downwardly from an upper surface 74. A generally rectangularly shaped trough 76 and an irregular triangularly shaped trough 78 are both located at both elongate ends of lidstock 70. A lower surface 82 of lidstock 70 closes the bottom of each of the wells 72.

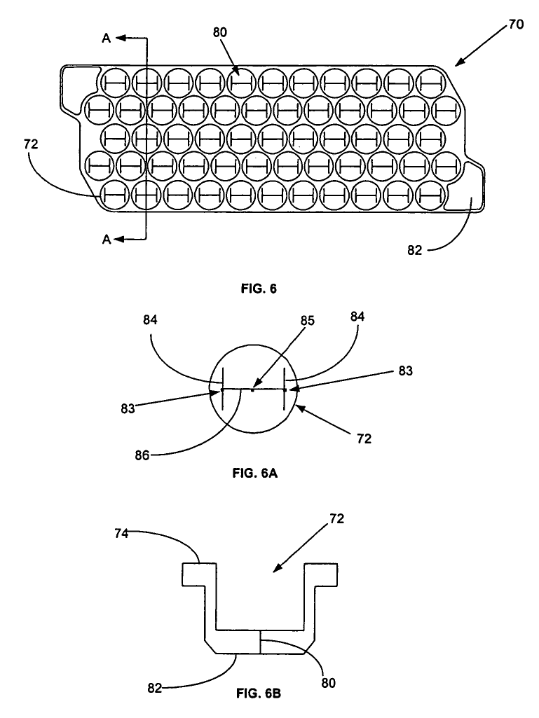

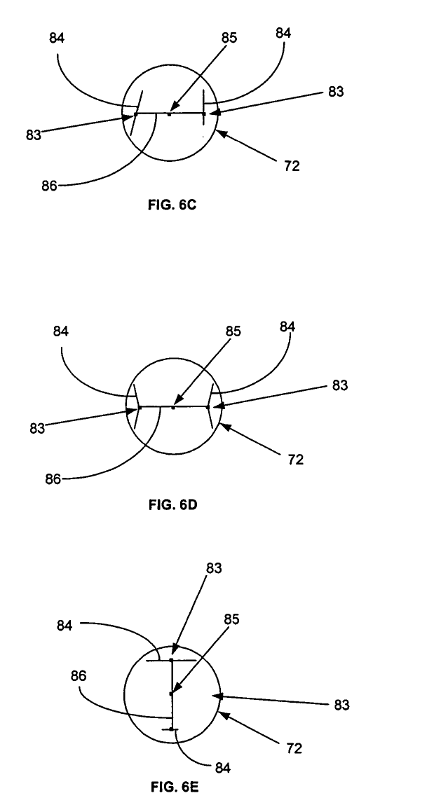

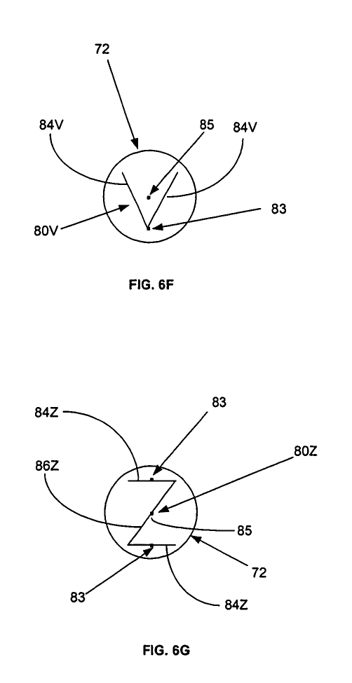

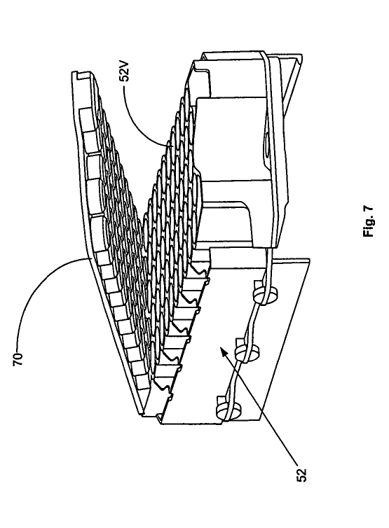

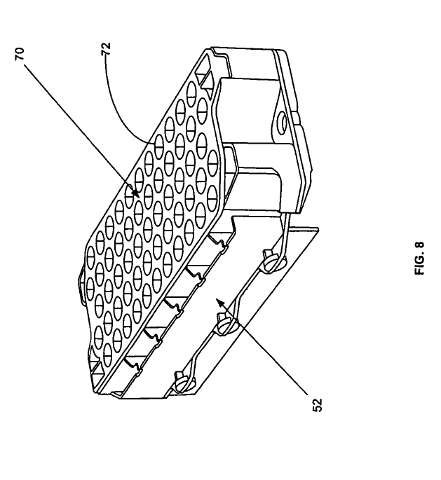

FIG. 6 is a bottom view of lidstock 70 and exemplifies a key feature of the present invention that provides for improved aspiration performance by slitting lidstock 70 to form segment intersections that facilitate penetration by probe 54P, the segment intersections being displaced from the location of penetration by probe 54P. In a first embodiment, like seen in FIG. 6A, a plurality of capital I-shaped slits 80 are formed in the bottom of each well 72 in a pattern that is distributed centered over individual vessels 52V. FIG. 7 illustrates how the plurality of wells 72 are distributed so as to mate with plurality of vessels 52V in a simplified aliquot vessel array 52 when partially applied to the aliquot vessel array 52 and FIG. 8 illustrates lidstock 70 fully applied to aliquot vessel array 52.

The I-shaped slit 80 exemplary of the present invention has been discovered to greatly improve the capability of lidstock 70 to provide sufficient venting to allow precision aspirations of small sample volumes as well as to withstand multiple aspirations without impairing the ability to reseal liquids in the individual vessels 52V when compared to previously employed slit shapes. Prior art line slits in particular adversely affect probe penetration because the force required to displace lidstock is greater than the force required to bend lidstock.

FIG. 6A is an enlarged view of the bottom of a well 72 and shows I-shaped slit 80 as comprising a pair of slit ends 84 distanced apart and connected at their mid-point intersections 83 by a slit cross member 86, the mid-point 85 of slit cross member 86 being located at the center of well 72. As provided by the present invention, segment intersections are formed at the mid-point intersections 83 of slit ends 84 and are displaced from the mid-point 85 of slit cross member 86, mid-point 85 being the location of penetration of lidstock 70 by probe 54P. Generally but not necessarily the pair of slit ends 84 are mutually parallel to one another and have equal lengths. FIG. 6B is a sectional view along line A-A of FIG. 6 and shows how I-shaped slit 80 is formed through the full bottom 82 of lidstock 80. In a typical embodiment, the length of slit ends 84 is generally about 60-75% of the length of slit cross member 86. For convenience during a manufacturing slitting operation, slit cross member 86 may extend a small distance beyond the intersection with slit ends 84

I-shaped, X-shaped, and star-shaped slits have been found to form segments that act to partially seal around an aspiration probe if the probe hits at the intersections of the individual slit segments, the seal creating a small vacuum within sample vessel 52V during aspiration. As previously mentioned, the vacuum will increase as aspiration continues causing the actual volume of aspirated sample to be smaller than the intended volume. In the present invention, however, the intersections 83 of the cross member 86 and slit ends 84 are displaced from the center of the individual sample vessels 52V where probe 54P is positioned by aspiration and dispense arm 54 to penetrate lidstock 74. The I-shaped slit 80 exemplifies the present invention in minimizing the possibility of lidstock 70 sealing around probe 54P by displacing the segment intersections from the penetration by probe 54P thereby significantly increasing the accuracy in volume of an aspirated sample. I-shaped slit 80 may also assume the shape of a capital “H” by rotating the cross member 86 by 90-degrees and extending the length of the slit ends 84 Further, as indicated in FIG. 6C, it is not required that the slit ends 84 be perpendicular to cross member 86 nor equal in length as long as the intersections 83 of the cross member 86 and slit ends 84 are displaced from the center of the individual sample vessels 52V where probe 54P is positioned by aspiration and dispense arm 54 to penetrate lidstock 74. FIG. 6D illustrates how it is not required that the slit ends 84 be straight as long as the intersections 83 of the cross member 86 and slit ends 84 are displaced from where probe 54P penetrates lidstock 74. FIG. 6E shows how I-shaped slit 80 may also assume the shape of a capital “T” by decreasing the length of one of the slit ends 84 and rotating slit 80 by 90-degrees.

In another alternate embodiment of the present invention, a plurality of capital V-shaped slits 80V, like seen in FIG. 6F may be formed in the bottom of each well 72, with the intersection 83 at the lower point of the capital-V intersected by angled side arms 84V displaced from the location of penetration by probe 54P at the midpoint 85 between the angled side arms 84V of the capital-V. In even another alternate embodiment of the present invention, a plurality of capital Z-shaped slits 80Z, like seen in FIG. 6G may be formed in the bottom of each well 72, with the intersections 83 of the upper and lower horizontal arms 84Z with the angled vertical member 86Z forming segment intersections displaced from the location of penetration by probe 54P at the midpoint 85 of the angled vertical member 86Z of the capital-Z. Henceforth the first embodiment will be discussed with equal applicability towards alternate embodiments.

In addition to the alternate embodiment employing capital V-shaped slits with the lower point of the V forming segment intersections displaced from the location of penetration by probe 54P between the vertically inclined arm-slits of the capital-V, other embodiments include a capital-T shaped slit with the intersection between the top and vertical slits displaced from the location of penetration by a probe in the midpoint of the vertical slit.

Table 1 below indicates how the I-shaped slit 80 provides for accuracy of aspiration aided by venting and protection of small sample volumes during multiple aspirations as compared to previously employed slit shapes. The term “Aspiration Performance” is used herein as the ration between the actual measured volume of an aspirated sample and the intended volume of an aspirated sample.

TABLE 1

| | | Evaporation |
|---|---|---|
| | Aspiration | Performance |
| Slit Shape | Performance | (% per day) |
| I-Shaped | 92% | 0.40% |
| Line-Shaped | 71% | 0.27% |
| X-Shaped | 78% | 0.81% |

Lidstock 70 is typically formed with a thickness of about 1 mm from silicone or a thermoplastic elastomer. Slit 80 is cut in a die-cutting press operation after lidstock 70 is molded into shape using an injection molding machine.

In operation of the analyzer of FIG. 1, an operator places a stack of aliquot vessel arrays 52 into any of several inventory shafts 55 within aliquot vessel array storage and handling unit 56 adapted to position aliquot vessel arrays 52 along any of several aliquot vessel array sampling tracks 60, as seen in FIG. 3. Aliquot vessel arrays 52 are precisely located within a track 60 by means of the zero-backlash hitch 64 coupled with a finger-latch 65 end portion of a linear drive mechanism 66. Each aliquot vessel array 52 is moved by motor 58 to a precisely positioned sampling location within track 60 whereat multiple aliquots of liquid sample may be aspirated from vessels 52V by means of a single aspiration through lidstock 70 covering aliquot vessel array 52. After multiple aspirations have removed sufficient liquid sample to perform all assays requested by CPU 15, aliquot vessel arrays 52 are returned to storage and handling unit 56 and may be inventoried within analyzer 10 within environmental chamber 38 or disposed into a waste (not shown).

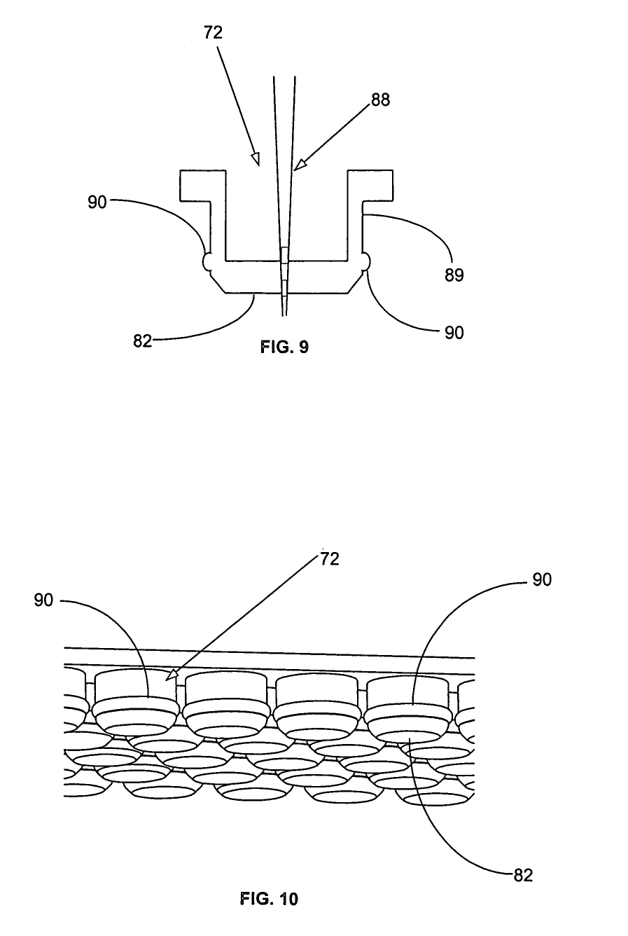

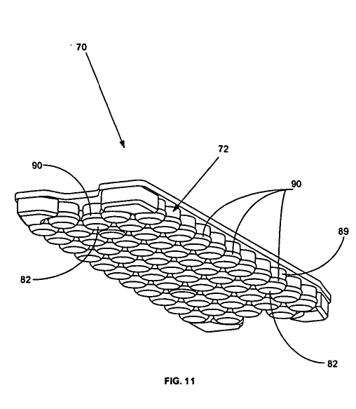

It has been also discovered that during aspiration through lidstock 70 using for example a probe 88 like that seen in FIG. 9, lidstock 70 is stretched downwardly and temporarily deformed. During the time of deformation, liquid contained in a vessel 52V wicks into the void formed between the lidstock well 72 and aliquot vessel array 52 and migrates out of the vessel 52V being aspirated and flows towards other vessels 52V proximate the vessel 52V being aspirated. This liquid then tends to be pumped towards other wells during subsequent penetrations ans aspirations by probe 88. Such liquid migration introduces the possibility of cross-contamination of sample liquids between different vessels 52V. One solution to this problem is the addition of an “O-ring”-like structure 90 formed on the external portion of the sidewall 89 extending outwardly therefrom and proximate the bottom 82 of each well 72 and fully encircling each well 72 like seen in FIG. 9. The “O-ring”-like structure 90 creates a concentrated area of interference between well 72 and aliquot vessel array 52 thereby maintaining contact between aliquot vessel array 52 walls and lidstock 70 during deformation of lidstock 70 and creating a barrier that sample fluid cannot pass through and cross-contaminate sample liquids within different vessels 52V. FIG. 10 is a perspective view of a portion of lidstock 70 having such a plurality of “O-ring”-like structures 90 formed on each one of the different wells 72 of lidstock 70 and FIG. 11 is a-perspective view of the entire lidstock 70 having a plurality of “O-ring”-like structures 90 formed on the sidewalls 89 proximate the bottoms 82 of each of the different wells 72 in lidstock 70.

It will be appreciated by those skilled in that art that a number of design variations may be made in the above and still achieve the essence of the present invention. Obviously the pattern of and dimension of wells in lidstock 70 is varied depending upon the pattern and dimensions of vessels 52V in array 52. In addition to the alternate embodiment employing capital V-shaped slits with the lower point of the V forming segment intersections displaced from the location of penetration by probe 54P between the vertically inclined arm-slits of the capital-V, other embodiments include a capital-T shaped slit with the intersection between the top and vertical slits displaced from the location of penetration by a probe in the midpoint of the vertical slit. For these reasons, the present invention is not limited to those embodiments precisely shown and described in the specification but only by the following claims.

1. A lidstock for a open sample container comprising a layer having a plurality of slits formed therein to form segment intersections that facilitate penetration by an aspiration probe, the segment intersections displaced from the location for penetration by the probe.

2. The lidstock of claim 1 further comprising at least one open generally circular well depending downwardly from an upper surface and a lower surface forming the bottom of each of the wells wherein the segment intersections are formed in the bottom of each well.

3. The lidstock of claim 2 wherein the segment intersections are formed as a capital I-shaped slit.

4. The lidstock of claim 2 adapted for use with an aliquot vessel array containing a plurality of liquid patient samples in a plurality of vessels, the lidstock further comprising at least one open generally circular well depending downwardly from an upper surface and a lower surface forming the bottom of each of the wells wherein the capital I-shaped slit is formed in the bottom of each well.

5. The lidstock of claim 4 wherein the plurality of wells are distributed to mate with the plurality of vessels.

6. The lidstock of claim 3 wherein the I-shaped slit comprises a pair of slit ends distanced apart and connected at their mid-points by a slit cross member.

7. The lidstock of claim 4 wherein the I-shaped slit comprises a pair of slit ends distanced apart and connected at their mid-points by a slit cross member and the mid-point of the slit cross member is located at the center of well.

8. The lidstock of claim 1 wherein the slits are formed fully through the bottom of the well.

9. The lidstock of claim 6 wherein the length of slit ends is generally about 60-75% of the length of cross member.

10. The lidstock of claim 6 wherein the slit cross member extends beyond the intersection with the slit ends.

11. The lidstock of claim 6 wherein the slit ends have equal lengths.

12. The lidstock of claim 2 wherein the segment intersections are formed as a capital V-shaped slit.

13. The lidstock of claim 2 wherein the segment intersections are formed as a capital T-shaped slit.

14. The lidstock of claim 2 wherein the wells have a circular sidewall closed by a bottom, the lidstock further comprising a plurality of “O-ring”-like structures formed on the sidewalls extending outwardly from each of the wells.

15. The lidstock of claim 14 wherein the “O-ring”-like structures formed on the sidewalls of the wells fully encircle the wells.

16. The lidstock of claim 14 wherein the “O-ring”-like structures formed on the sidewalls of the wells are formed proximate the bottom of the wells.
